(19) United States
(12) Patent Application Publication
(10) Pub. No.: US 2014/0260053 A1
(43) Pub. Date: Sep. 18, 2014

(54) COLUMNAR STRUCTURAL COMPONENT AND METHOD OF FORMING

(71) Applicant: MILLPORT ASSOCIATES S.A., City of Panama (PA)

(72) Inventor: Ulrich Schwartau, Port d Andratx (ES)

(73) Assignee: MILLPORT ASSOCIATES S.A., City of Panama (PA)

(21) Appl. No.: 13/804,628

(22) Filed: Mar. 14, 2013

(51) Int. Cl. E04C 2/32; E04C 2/38; B32B 37/14; E04C 3/36

(52) U.S. Cl. CPC E04C 2/328; E04C 2/324; E04C 3/36; E04C 2/38; B32B 37/142
USPC 52/578; 52/834; 428/174; 428/172; 156/182

(57) ABSTRACT

A columnar structural component includes a first sandwich panel bent to bound at least part of an area and a number of generally planar sandwich panels arranged to form a stack of sandwich panels. The stack of sandwich panels is at least partially in the area bounded by the first sandwich panel and the first sandwich panel and the stack of sandwich panels are cooperative with one another to form a columnar structural component.

### TECHNICAL FIELD OF THE INVENTION

The present invention relates generally to constructing buildings, and more particularly, to a columnar structural component and a method of forming a columnar structural component from a number of composite sandwich panels.

### DESCRIPTION OF THE RELATED ART

There is an increasing global demand for lower cost buildings such as houses, warehouses and office space. The demand for lower cost buildings is particularly strong in developing countries where economic resources may be limited and natural resources and raw materials may be scarce. For example, in areas of the Middle East or Africa, conventional building materials such as cement, brick, wood or steel may not be readily available or, if available, may be very expensive. In some areas of the world, poverty may make it too costly for people to build houses or other buildings with conventional materials.

The demand for lower cost housing also is high in areas afflicted by war or by natural disasters, such as hurricanes, tornados, floods, and the like. These devastating events often lead to widespread destruction of large numbers of buildings and houses, especially when they occur in densely populated regions. The rebuilding of areas affected by these events can cause substantial strain on the supply chain for raw materials, making them difficult or even impossible to obtain. Furthermore, natural disasters often recur and affect the same areas. If a destroyed building is rebuilt using the same conventional materials, it stands to reason that the building may be destroyed or damaged again during a similar event.

It is generally desirable to increase speed of construction and to minimize construction costs. Prefabricated or preassembled components can streamline production and reduce both the time and the cost of building construction. Prefabricated buildings, however, are made from conventional materials that may be scarce or expensive to obtain. Thus, there exists a need for alternative materials and techniques for constructing buildings that use advanced material technologies to increase the speed of construction and to reduce or to lower ownership costs.

### SUMMARY

The present invention provides an alternative to conventional construction materials and techniques. Buildings, such as houses, commercial buildings, warehouses, or other structures can be constructed by composite sandwich panels (also referred to as “sandwich panels” or “composite panels” or “panels”), which have an insulative core and one or more outer layers. The buildings can be constructed by gluing several sandwich panels together, and usually traditional fasteners, such as screws, rivets, nails, etc., are not needed for such connections. Generally, composite sandwich panels offer a greater strength-to-weight ratio than traditional materials that are used by the building industry. The composite sandwich panels are generally as strong as, or stronger than, traditional materials including wood-based and steel-based structural insulation panels, while being lighter in weight. Because they weigh less than traditional building materials, the handling and transport of composite sandwich panels is generally less expensive. The composite sandwich panels also can be used to produce light-weight structures, such as floating houses, mobile homes, or travel trailers, etc.

Sandwich panels generally are more elastic or flexible than conventional materials such as wood, concrete, steel or brick and, therefore, monolithic (e.g., unitary or single unit structure) buildings made from sandwich panels generally are more durable than buildings made from conventional materials. For example, sandwich panels also may be non-flammable, waterproof, very strong and durable, and in some cases able to resist hurricane-force winds (up to 300 Kph (kilometers per hour) or more). The sandwich panels also may be resistant to the detrimental effects of algae, fungicides, water, and osmosis. As a result, buildings constructed from sandwich panels may be better able to withstand earthquakes, floods, tornados, hurricanes, fires and other natural disasters than buildings constructed from conventional materials.

Sandwich panel structures may be less expensive to build than structures built from conventional materials because of reduced material costs and alternative construction techniques. The ownership and maintenance costs for sandwich panel structures also may be less over the long term because sandwich panel structures may last longer and degrade at a slower rate than buildings made from conventional materials. Structures built from sandwich panels therefore may require less maintenance and upkeep than structures built from conventional building materials, which may reduce the overall ownership costs for end users.

The insulative core of the sandwich panels also may reduce the amount of energy needed to heat and/or cool the building, which may reduce the overall costs to operate the building. The insulative core also may reduce or eliminate the need for additional insulation in the building, as may be necessary to insulate structures built from conventional building materials. Sandwich panel structures therefore may be less expensive to build and operate than building constructed from conventional building materials.

Standard sandwich panels generally are planar building elements. In many cases, it may be desirable to impart or to form a curve or a round corner in a sandwich panel for aesthetic and/or functional purposes. For example, it may be desirable to incorporate one or more columnar structural components (also referred to as a “columns”) in a monolithic structure. The columnar structural components may have one or more curved or rounded corners or surfaces. The terms “round,” “rounded,” “curve,” and “curved” are used interchangeably to describe objects or surfaces that are non-linear or non-planar in shape. Such objects may be circular in shape, or may have another non-linear or non-planar shape.

As described below, the columnar structural component includes a first sandwich panel that is bent to bound at least part of an area. A number of generally planar sandwich panels arranged to form a stack of sandwich panels. The stack of sandwich panels is arranged such that the stack is at least partially contained in the area bounded by bent sandwich panel. The sandwich panel and the stack of sandwich panels are cooperative with one another to form the columnar structural component.

According to one aspect of the invention a structural component includes a first sandwich panel bent to bound at least part of an area, a number of generally planar sandwich panels arranged to form a stack of sandwich panels, the stack of sandwich panels at least partially in the area bounded by the first sandwich panel, and the first sandwich panel and the stack of sandwich panels being cooperative with one another to form a columnar structural component.

According to another aspect, the first sandwich panel includes a number of sets of recesses and the first sandwich panel is bent in the area of the sets of recesses.

According to another aspect, each of the number of sets of recesses includes at least one substantially continuous channel.

According to another aspect, the at least one substantially continuous channel has a triangular cross-section.

According to another aspect, the number of sets of recesses includes a first set of recesses and a second set of recesses and wherein the first sandwich panel has a first curved corner at the first set of recesses and a second curved corner at the second set of recesses.

According to another aspect, the first sandwich panel includes a first edge and a second edge and wherein the first edge is substantially coplanar with the second edge.

According to another aspect, the stack of sandwich panels includes an edge that is substantially coplanar with the first edge and the second edge of the first sandwich panel.

According to another aspect, the stack of sandwich panels is retained in the area bound by the first sandwich panel with a connecting member.

According to another aspect, the connecting member is a planar element that is connected to the first edge and the second edge of the of the first sandwich panel.

According to another aspect, the connecting member is at least one layer of laminate material.

According to another aspect, the stack of sandwich panels includes a number of stiffeners.

According to another aspect of the invention, a method of forming a columnar structural component includes forming a number of sets of recesses in a first sandwich panel, bending the first sandwich panel in the area of each of the sets of recesses to at least partially bound an area, arranging a number of generally planar sandwich panels in a stack, and cooperatively engaging the stack of sandwich panels and the first sandwich panel such that the stack of sandwich panels is at least partially in the area bounded by the first sandwich panel.

According to another aspect, the method includes forming a first set of recesses and a second set of recesses in the first sandwich panel.

According to another aspect, the forming includes forming a number of recesses having a triangular cross-section.

According to another aspect, the bending includes bending the sandwich panel at the first set of recesses to form a first round corner and bending the sandwich panel at the second set of recesses to form a second round corner.

According to another aspect, the bending further includes bending the first sandwich panel such that a first edge of the sandwich panel is generally coplanar with a second edge of the sandwich panel.

According to another aspect, the cooperatively engaging includes inserting the stack of sandwich panels at least partially into the area bounded by the first sandwich panel.

According to another aspect, the cooperatively engaging includes bending the first sandwich panel at least partially around the stack of sandwich panels.

According to another aspect, the cooperatively engaging includes inserting the stack of sandwich panels into the area bounded by the first sandwich panel such that an edge of the stack of sandwich panels is coplanar with a first edge and a second edge of the first sandwich panel.

According to another aspect, the cooperatively engaging includes connecting a connecting member to the first edge and the second edge of the first sandwich panel.

According to another aspect, a column includes a first sandwich panel having a first edge and a second edge, a number of generally planar sandwich panels arranged in a stack of sandwich panels, wherein the stack of sandwich panels is at least partially surrounded by the first sandwich panel, and a connecting member connected to the first edge and the second edge of the first sandwich panel.

According to another aspect, the first edge and the second edge of the first sandwich panel are substantially coplanar with one another.

According to another aspect, the stack of sandwich panels has an edge that is substantially coplanar with the first edge and the second edge of the first sandwich panel.

According to another aspect, the first sandwich panel has a first round corner and a second round corner.

According to another aspect, the first round corner and the second round corner are each about 90-degrees.

According to another aspect, the number of generally planar sandwich panels are connected together to form the stack of sandwich panels.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

It should be emphasized that the term “comprises/comprising” when used in this specification is taken to specify the presence of stated features, integers, steps or components but does not preclude the presence or addition of one or more other features, integers, steps, components or groups thereof.

Features that are described and/or illustrated with respect to one embodiment may be used in the same way or in a similar way in one or more other embodiments and/or in combination with, or instead of, the features of the other embodiments.

### BRIEF DESCRIPTION OF THE DRAWINGS

FIG. 1 is an environmental view of an exemplary monolithic structure built from composite materials.

FIG. 2 is an isometric view of an exemplary columnar structural component made from sandwich panels.

FIG. 3A is a schematic cross-sectional view of a sandwich panel.

FIG. 3B is a schematic cross-sectional view of a sandwich panel with a number of sets of recesses.

FIG. 3C is a front view of the sandwich panel of FIG. 3B.

FIG. 4A is a schematic cross-sectional view of a sandwich panel bent to form first and second round corners.

FIG. 4B is a side view of the sandwich panel of FIG. 4A looking generally in the direction of the arrows 4B-4B.

FIG. 5A is a schematic cross-sectional view of the sandwich panel of FIG. 4A partially surrounding a stack of sandwich panels.

FIG. 5B is a side view of the sandwich panels of FIG. 5A looking generally in the direction of the arrows 5B-5B.

FIG. 6A is a schematic cross-sectional view of an embodiment of an exemplary columnar structural component.

FIG. 6B is a side view of the columnar structural component of FIG. 6A looking generally in the direction of the arrows 6B-6B.

FIG. 7A is a schematic cross-sectional view of another embodiment of an exemplary columnar structural component.

FIG. 7B is a side view of the columnar structural component of FIG. 7A looking generally in the direction of the arrows 7B-7B.

FIG. 8 is a schematic sectional view of a columnar structural component connected to a wall.

FIG. 9 is an isometric view of an exemplary sandwich panel.

### DETAILED DESCRIPTION OF EMBODIMENTS

In the detailed description that follows, like components have been given the same reference numerals regardless of whether they are shown in different embodiments of the invention. To illustrate the present invention in a clear and concise manner, the drawings may not necessarily be to scale and certain features may be shown in somewhat schematic form. Certain terminology is used herein to describe the different embodiments of the invention. Such terminology is used for convenience when referring to the figures. For example, “upward,” “downward,” “above,” “below,” “left,” or “right” merely describe directions in the configurations shown in the figures. Similarly, the terms “interior” and exterior” or “inner” and “outer” may be used for convenience to describe the orientation of the components in the figures. The components can be oriented in any direction and the terminology should therefore be interpreted to include such variations. The dimensions provided herein are exemplary in nature and are not intended to be limiting in scope. Furthermore, while described primarily with respect to house construction, it will be appreciated that the concepts described herein are equally applicable to the construction of any type of structure or building, such as a warehouse, commercial building, factory, apartment building, etc.

The structures described herein are built with composite materials, such as composite sandwich panels. The sandwich panels may be formed from synthetic or natural materials and may provide a light-weight and potentially less expensive alternative to conventional raw materials, e.g., wood, concrete, metal, etc. The sandwich panels may be connected or joined together with a high-strength bonding material, such as epoxy or glue. The result is a strong and durable monolithic structure, as is described further below.

Referring to FIG. 1, an exemplary monolithic structure 10, for example, a house, is built from a number of sandwich panels that are connected together with bonding material. A front wall 10f of the house 10 is formed by connecting together sandwich panels 11-16 with bonding material. A side wall 10s of the house 10 is formed by connecting together sandwich panels 20-23 with bonding material. A top portion 10t of the house 10 is supported by a bottom portion 10b of the house 10. To support the top portion 10t of the house 10, the bottom portion 10b may include a number of columnar structural components 25 formed from composite sandwich panels, as is described in more detail below. The house 10 also includes a roof 26 connected to the walls 10f, 10s and a number of prefabricated openings 27, for example, for installing doors or windows, etc. Although not shown in FIG. 1, it will be appreciated that the house 10 may include a number of other walls, e.g., another side wall, a rear wall, internal walls, etc.

Columnar structures have strength characteristics; sandwich panels 30 have strength characteristics; some exemplary strength characteristics are described below. A column formed of a sandwich panel, e.g. a sandwich panel that is integrated and is bent to form the column, may have strength characteristics of both columnar shape and sandwich panel construction.

As shown in FIG. 1, the columns 25 may be spaced throughout the house 10, for example, the columns 25 may be located along the edges or exterior of the house and/or may be located in the middle of the house 10, etc. The columns 25 may be used to support a ceiling or floor portion 28 of the house 10 or another portion of the house 10.

Referring to FIG. 2, an exemplary columnar structural component 25 (or column) is formed from a number of sandwich panels. To make a column 25 a sandwich panel 30 is bent to form the respective corners to provide a column having a longitudinal axis or extent. The column 25 includes a sandwich panel 30 that has an outer layer 31. The sandwich panel 30 is formed into a number of round corners 32a, 33a by cutting or forming one or more sets of recesses 32b, 33b along a length L of the sandwich panel 30. The recesses 32b, 33b provide stress relief and/or otherwise facilitate bending the panel in a controlled manner to achieve a desired shape, bend, corner, etc., and, for example, tending to avoid damage to the sandwich panel as it is bent or folded.

The sandwich panel 30 has a first edge 34 and a second edge 35. The sandwich panel 30 is bent in the area of the recesses 32b, 33b to form the round corners 32a, 33a and corresponding inner corners 32c, 33c.

The sandwich panel 30 is bent such that the first edge 34 and the second edge 35 are substantially coplanar with one another. The bent sandwich panel 30 at least partially bounds or defines an area 36. As used herein, the term “bound” means to partially or completely surround, enclose, or encompass an area or volume, and the terms “area” and “volume” are used interchangeably to mean a “space” or “region.” The bound area 36 generally is shaped to receive or to surround a stack 37 of sandwich panels 40-43. As shown in the embodiments of FIG. 2, the general shape of the bent sandwich panel 30 may be a “U” or a “C” shape.

The sandwich panel 30 and the stack of sandwich panels 37 may be cooperatively engaged by inserting the stack of sandwich panels 37 at least partially into the area 36 bounded by the first sandwich panel 30. The stack 37 has an edge 44. As shown in FIG. 2, the stack 37 of sandwich panels has an edge 44. The stack 37 of sandwich panels is inserted into the area 36 such that the edge 44 of the stack 37 is substantially coplanar with the edges 45, 46 of the sandwich panel 30. Alternatively, the sandwich panel 30 may be bent or formed around the stack 37 of sandwich panels.

The sandwich panels 40-43 may include a number of stiffeners 45, 46 integrated or formed in the panel cores to stiffen the sandwich panels 40-43 and/or to strengthen the column, for example, to support higher loads or to increase the rigidity of the column. A connecting member 47 is connected to the edges 34, 35 of the sandwich panel 30 or to close the area 36.

Referring to FIG. 3A-FIG. 8, a column or structural component 25 and exemplary method of forming the column or structural component 25 from a planar sandwich panel 30 are illustrated. As shown in FIG. 3A, the sandwich panel 30 includes a first outer layer 31 and a second outer layer 51 separated from the first outer layer 31 by a panel core 52. The first outer layer 31, the second outer layer 51, and the panel core 52 are substantially planar. The sandwich panel 30 also includes a first edge 34 and a second edge 35. Additional details of an exemplary sandwich panel are provided below with respect to FIG. 9.

As shown in FIGS. 3B-3C, one or more sets of recesses 32b, 33b (also referred to as channels) are formed in the second outer layer 51 and the panel core 52. Each set of recesses 32b, 33b includes one or more substantially continuous channel that extends from a first end 53 of the sandwich panel 30 to a second end 54 of the sandwich panel 30, e.g., along a length L of the sandwich panel 30. In FIGS. 3B-3C, each set of recesses 32b, 33b is illustrated as including three substantially continuous channels extending between the ends 53, 54. As will be appreciated, the three substantially continuous channels in the sets of recesses 32b, 33b are exemplary in nature and each set of recesses 32b, 33b may include a more or less than three substantially continuous channels, as may be desired.

The sets of recesses 32b, 33b may have any desired shape. As illustrated in FIG. 3B, the sets of recesses 32b, 33b may have a triangular shape. A triangular shape may be desirable for sandwich panels that are to be bent at an angle and/or have a small radius to form a round corner (e.g., the round corners 32a, 33a), as shown in FIG. 2. The triangular shape may be an isosceles triangle having an angle θ (theta). In one embodiment, the angle θ (theta) may be about 10-30 degrees. The recesses 32b, 33b may be a different shape and the angle θ (theta) as well of the depth of the recesses 32b, 33b, may be selected to achieve a desired radius of the round corners or to form a round corner having a different size or shape, as will be appreciated by one of skill in the art. It will be appreciated that the recesses may have a shape of a rectangle, square, or another shape, and that all of the recesses may not be identically shaped.

The sets of recesses 32b, 33b may be formed in the sandwich panel 30 during manufacture of the sandwich panel 30 and/or on-site during the building construction process. During the manufacturing process, the sandwich panel may be molded to include the sets of recesses 32b, 33b. Alternatively, after the sandwich panel is constructed, a tool (e.g., a saw) may be applied to the sandwich panel to cut or to form the desired number, size and shape of the recesses 32b, 33b.

The sets of recesses 32b, 33b are spaced apart from one another based upon the desired shape of the column 25. To form a generally square-shape or rectangular-shape column with round corners, e.g., the column 25 of FIG. 2, two sets of recesses 32b, 33b are formed in the outer layer 51 and the core 52. The sets of recesses 32b, 33b may be spaced from one another a distance W₁. For example, as shown in FIG. 3C, the first set of recesses 31b is spaced from the second set of recesses 32b a distance W₁. The first set of recesses 31b is spaced from the edge 34 of the sandwich panel 30 a distance W₂. The second set of recesses 32b are spaced from the second edge 35 a distance W₂.

In general, the distance W₁ is less than the distance W₂, however, it will be appreciated that the distance W₂ may be about the same as the distance W₁ or may be smaller or greater than the distance W₁. In one embodiment, the distances W₁ and W₂ are based upon the size, shape and/or number of sandwich panels in the stack 37 of sandwich panels 40-43 that is inserted into the area 36 or around which the sandwich panel 30 may be formed or bent to impart or to form the round corners 32a, 33a. For example, if the stack 37 includes a single sandwich panel, then the distance W₁ may be about 65 mm (millimeters), and if the stack 37 includes five sandwich panels, then distance W₁ may be about 325 mm (millimeters). It will be appreciated that the distance W₁ may be between about 65 mm (millimeters)-about 325 mm (millimeters). The distance W₁ may be less than about 65 mm (millimeters) or greater than 325 mm (millimeters) based on the size of the sandwich panels and/or the number of sandwich panels in the stack 37 of sandwich panels, which may, for example, include more or less than five sandwich panels.

The distance W₂ may be between about 62 mm (millimeters)-500 mm (millimeters) and may be based upon the shape and/or size of the column. It will be appreciated that the distance W₂ may be less than about 62 mm (millimeters) or greater than about 500 mm (millimeters), as may be desired.

The distances W₁ and W₂ may be selected such that the edges 34, 35 of the sandwich panel 30 are substantially coplanar with the edge 44 of the stack 37 of sandwich panels when the sandwich panel 30 is bent to form round corners 32a, 33a. Thus, the sandwich panel 30 and the stack 37 of sandwich panels are cooperative with or cooperatively engaged with one another by inserting the stack 37 of sandwich panels at least partially into the area 36 bounded by the first sandwich panel 30 or by bending the sandwich panel 30 to at least partially surround the stack of sandwich panels 37.

In one embodiment, the number, size and/or shape of the recesses in the sets of recesses 32b, 33b are based at least on the desired shape and/or radius of the round corners. In another embodiment, the size and shape of the recesses is selected based at least in part on a thickness of the sandwich panel plus glue or bonding material.

Referring to FIGS. 4A and 4B, the column 25 may be formed by bending the sandwich panel 30 to form a first round corner 32a and a second round corner 33a. Referring briefly to FIG. 3B, the first round corner 32a may be formed by applying a force F that is generally perpendicular to the outer layer 31 at or near the edge 35 to bend the sandwich panel 30. The bending of the sandwich panel 30 compresses the channels of the set of recesses 32b and generally eliminates most or all of the air or space in the channels. The flexibility of the outer layer 31 allows the outer layer 31 to flex or to bend in the area of the set of recesses 32b to form the first round corner 32a in the outer layer 31. The second round corner 33a is formed in a substantially similar manner by applying a force to the edge 35 to bend the sandwich panel 30 in the area of the second set of recesses 33b. The first round corner 32a and the second round corner 33a may be formed at the same time or may be formed consecutively, for example one after the other, or in another manner.

As shown in FIG. 4A, each round corner 32a, 33a includes an opposing side that forms an inner corner 32c, 33c. For example, the first round corner 32a has an opposing inner corner 32c. The inner corner 32c includes a portion of the second outer layer 51 and a portion of the set of recesses 32b. The second round corner 33a includes a similarly shaped inner corner 33c that includes a portion of the second outer layer 51 and a portion of the set of recesses 33b.

Bonding material 53 may be applied to the first inner corner 32c. The bonding material 50 spans across the inner corner 32c such that the bonding material is on both sides of the inner corner 32c. The bonding material 53, therefore, bonds to the second outer layer 51 to maintain the bent configuration (e.g., the round corner 32a) of the sandwich panel 30 and to seal the inner corner 32c. Bonding material 54 may be applied to the second inner corner 33c in the same or a similar manner to maintain the round corner 32a. The bonding material 53, 54, which is described in more detail below, may be of sufficient strength to permanently fix or hold the round corners 31a, 32a in the outer layer 31 of the sandwich panel 30.

When the sandwich panel 30 is bent to form the first round corner 32a and second round corner 33a, the sandwich panel 30 bounds or partially bounds the area 36. The area 36 is defined or formed by a portion of the second outer layer 51 that extends between the first edge 34 and the first inner corner 32c, a portion to the second outer layer 51 that extends between the first inner corner 32c and the second inner corner 33c, and a portion of the outer layer 51 that extends between the second inner corner 33c and the second edge 35. The area 36 may be shaped to cooperate with, to cooperatively engage, or to receive one or more sandwich panels (e.g. the stack 37 of sandwich panels 40-43). The distances W₁ and W₂ may be selected or determined such that the sandwich panel 30 can be bent to accommodate different size stacks of sandwich panels, as will be appreciated.

It will be appreciated that the sandwich panel 30 may be bent to bound an area 36 to accommodate differently shaped stacks of sandwich panels. It also will be appreciated that the stack 37 of sandwich panels may be formed to fit within the area 36, and may, for example, be cut, molded or otherwise modified to fit into an area 36 of any shape.

As shown in FIG. 4A, the sandwich panel 30 is bent to create or to form round corner 32a, 33a. The round corners 32a, 33a may be about 90-degrees. It will be appreciated that although described as a rectangular column having round corners of about 90-degrees, the round corners 32a, 33a may be formed to have any desired angle and/or curvature to form columnar elements having different shapes, e.g., columns having round corners that are greater than or less than 90-degrees. The distances W₁ and W₂ and the number of sets of recesses also may be spaced from one another to obtain the desired dimensions of the column and/or to form a column having different shapes, for example, a circular, triangular, rectangular, pentagonal or another polygonal shape, etc., as will be appreciated by one of skill in the art.

Referring to FIGS. 5A-5B, the stack 37 of sandwich panels is formed by arranging a number of generally planar sandwich panels 40-43 in a stack. Each of the sandwich panels 40-43 include two outer layers separated from one another by a core, as described in more detail below with respect to the exemplary sandwich panel described in FIG. 9. The sandwich panels 40-43 may be connected together with bonding material, which may be spread between the sandwich panels and which may rigidly hold or bond the panels together. Exemplary bonding materials are described in more detail below. It will be appreciated that while illustrated as having four sandwich panels 40-43, the stack 37 may include additional or fewer sandwich panels, as may be desired.

The stack 37 of sandwich panels is partially or fully inserted or placed in the area 36 bound by the sandwich panel 30 to strengthen, stiffen and/or reinforce the column 25. The stack 37 also may help to maintain the general shape of the column 25 and may facilitate the formation of the column 25. The sandwich panel 30 may be formed and/or bent around the stack 37. The stack 37 may be wedged or held in the area 36 a friction fit.

The core of each sandwich panel 40-43 may include a number of stiffeners 45 to reinforce the column 25 and/or to increase the load-bearing potential of the column 25. The stiffeners 45 may be incorporated into the core of the sandwich panels 40-43. In one embodiment, the stiffeners are made from materials having the same thermal expansion properties as the materials used to construct the panel, such that the stiffeners expand and contract with the rest of the panel when the panel is heated or cooled. The stiffeners 45 may be about 25 mm (millimeters)-75 mm (millimeters) wide. It will be appreciated that the stiffeners 45 may be wider or thinner, as may be desired. Additional details related to the stiffeners are provided below with respect to FIG. 9.

The stiffeners may be spaced about 15 cm (centimeters)-100 cm (centimeters) apart from one another. In one embodiment, the stiffeners in each sandwich panel are spaced about 15 cm (centimeters) apart. To support higher loads, the distance between the stiffeners 45 may be smaller. It also will be appreciated that the stiffeners 45 may be spaced closer than 15 cm (centimeters) together or further apart than 100 cm (centimeters), as may be desired.

As shown in FIG. 5A, the stiffeners 45 may be aligned with one another when the panels 40-43 are connected together in the stack 37. It will be appreciated that the stiffeners 45 may be arranged in any configuration, for example, the stiffeners 45 in the sandwich panels 40-43 may be staggered relative to one another. It also will be appreciated that the stiffeners 45 may be incorporated into some of the sandwich panels and not others.

As illustrated in FIG. 5A-5B, the stack 37 includes four sandwich panels 40-43. The stack 37 of sandwich panels 40-43 includes an edge 44. The stack 37 may be surrounded by the sandwich panel 30 such that the edge 44 of the stack 37 is substantially coplanar with the first edge 34 and the second edge 35 of the sandwich panel 30.

The stack 37 may be connected to the sandwich panel 30 with bonding material. For example, bonding material may be spread or be applied between the second outer layer 51 and the stack 37. In one embodiment, the bonding material is applied at least along one edge of the stack 37, for example, the edge of the stack between the first inner corner 32c and the second inner corner 33c of the sandwich panel 30. Bonding material also may be applied to connect the stack 37 to the outer layer 51 between the first edge 34 and the first inner corner 32c and/or bonding material may be applied to connect the stack 37 to the outer layer 51 between the second inner corner 33c and the second edge 35. The bonding material that connects the stack 37 to the outer layer 51 also may include a portion of the bonding material 53, 54 applied at the inner corners 32c, 33c. Exemplary bonding materials are described in more detail below.

Referring to FIGS. 6A and 6B, the area 36 is enclosed or bound by a connecting member 47. The connecting member 47 is attached to the first edge 34 of the sandwich panel 30 and to the second edge 35 of the sandwich panel 30. The connecting member 47 may be connected to the edges 34, 35 by bonding material spread or applied between the edges 34, 35 and the connecting member 47. The connecting member 47 also may provide a planar surface to mount or to connect the column 25 to a wall or other portion of the house 10.

The connecting member 47 may be connected to the stack 37 of sandwich panels with bonding material. The connecting member 47 also may retain the stack 37 of sandwich panels in the area 36.

The connecting member 47 may be a planar element and may be one or more layers of laminate, for example, one or more layers of fiber glass. The connecting member 47 may be a sandwich panel of the same type as panel 30. The connecting member may be the same material as the outer layers 31, 51 of the sandwich panel 30. Additional bonding material may be applied at the edge of the stack 37 of sandwich panels 40-43 to connect the stack 37 to the connecting member 47.

Referring to FIGS. 7A and 7B, the connecting member 48 is a sandwich panel. The sandwich panel connecting member 48 is connected to the first edge 34 and the second edge 35 of the sandwich panel 30 with bonding material. Additional bonding material may be applied between the edge 44 of the stack 37 of sandwich panels 40-43 and the sandwich panel. It also will be appreciated that the connecting member 48 may be a wall of a building or other structure, for example, wall 10f or wall 10s of the house 10.

It may be necessary to hold the sandwich panel 30 in the configuration of FIG. 5A, 6A or 7A for a period of time to allow the bonding material time to cure or to harden. One or more clamps may be used to maintain the configuration of the sandwich panel 30. Once the bonding material cures or hardens, the sandwich panel 30 is generally permanently maintained in the configuration of the Figures (e.g., a sandwich panel 30 with round corners 32a, 33a).

Referring to FIG. 8, the column 25 is shown connected to a wall 49, which may, for example, be made from a sandwich panel. The column 25 can be connected to the wall 49 with bonding material, which may be applied along the surface of the sandwich panel 49 and/or the connecting member 47. The bonding material forms a rigid and generally permanent connection between the column 25 and the wall 49.

Referring to FIG. 9, an exemplary sandwich panel 70 is illustrated. The sandwich panel has two outer layers 72, 74 separated by a core 76. The outer layers 72, 74 of the sandwich panel 70 are made from a composite material that includes a matrix material and a filler or reinforcement material. Exemplary matrix materials include a resin or mixture of resins, e.g., epoxy resin, polyester resin, vinyl ester resin, natural (or non oil-based) resin or phenolic resin, etc. Exemplary filler or reinforcement materials include fiberglass, glass fabric, carbon fiber, or aramid fiber, etc. Other filler or reinforcement materials include, for example, one or more natural fibers, such as, jute, coco, hemp, or elephant grass, balsa wood, or bamboo.

The outer layers 72, 74 (also referred to as laminates) may be relatively thin with respect to the panel core 76. The outer layers 72, 74 may be several millimeters thick and may, for example, be between about 1 mm (millimeter)-12 mm (millimeters) thick; however, it will be appreciated that the outer layers can be thinner than 1 mm (millimeter) or thicker than 12 mm (millimeters) as may be desired. In one embodiment, the outer layers are about 1-3 mm (millimeters) thick.

It will be appreciated that the outer layers 72, 74 may be made thicker by layering several layers of reinforcement material on top of one another. The thickness of the reinforcement material also may be varied to obtain thicker outer layers 72, 74 with a single layer of reinforcement material. Further, different reinforcement materials may be thicker than others and may be selected based upon the desired thickness of the outer layers.

The panel core 76 separates the outer layers 72, 74 of the sandwich panel 70. The panel core 76 may be formed from a light-weight, insulative material, for example, polyurethane, expanded polystyrene, polystyrene hard foam, Styrofoam® material, phenol foam, a natural foam, for example, foams made from cellulose materials, such as a cellulosic corn-based foam, or a combination of several different materials. Other exemplary panel core materials include honeycomb that can be made of polypropylene, non-flammable impregnated paper or other composite materials. It will be appreciated that these materials insulate the interior of the structure and also reduce the sound or noise transmitted through the panels, e.g., from one outer surface to the other or from an exterior to an interior of a building structure, etc. The panel core 76 may be any desired thickness and may be, for example, 30 mm (millimeters)-100 mm (millimeters) thick; however, it will be appreciated that the core can be thinner than 30 mm (millimeters) or thicker than 100 mm (millimeters) as may be desired. In one embodiment, the core is approximately 40 mm (millimeters) thick.

The outer layers 72, 74 are adhered to the core 76 with the matrix materials, such as the resin mixture. Once cured, the outer layers 72, 74 of the sandwich panel 70 are firmly adhered to both sides of the panel core 76, forming a rigid building element. It will be appreciated that the resin mixture also may include additional agents, such as, for example, flame retardants, mold suppressants, curing agents, hardeners, etc. Coatings may be applied to the outer layers 72, 74, such as, for example, finish coats, paint, ultraviolet (UV) protection, water protection, etc.

The panel core 76 may provide good thermal insulation properties and structural properties. The outer layers 72, 74 may add to those properties of the core and also may protect the panel core 76 from damage. The outer layers 72, 74 also may provide rigidity and support to the sandwich panel 70.

The sandwich panels may be any shape and size. In one embodiment, the sandwich panels are rectangular in shape and may be several meters, or more, in height and width. The sandwich panels also may be other shapes and sizes. The combination of the panel core 76 and outer layers 72, 74 create sandwich panels with high ultimate strength, which is the maximum stress the panels can withstand, and high tensile strength, which is the maximum amount of tensile stress that the panels can withstand before failure. The compressive strength of the panels is such that the panels may be used as both load bearing and non-load bearing walls. In one embodiment, the panels have a load capacity of at least 50 tons per square meter in the vertical direction (indicated by arrows V in FIG. 9) and 2 tons per square meter in the horizontal direction (indicated by arrows H in FIG. 9). The sandwich panels may have other strength characteristics as will be appreciated in the art.

Internal stiffeners may be integrated into the panel core 76 to increase the overall stiffness of the sandwich panel 70. In one embodiment, the stiffeners are made from materials having the same thermal expansion properties as the materials used to construct the panel, such that the stiffeners expand and contract with the rest of the panel when the panel is heated or cooled.

The stiffeners may be made from the same material used to construct the outer layers of the panel. The stiffeners may be made from composite materials and may be placed perpendicular to the top and bottom of the panels and spaced, for example, at distances of about 10 cm (centimeters), 25 cm, 50 cm, or 100 cm. Alternatively, the stiffeners may be placed at different angles, such as a 45-degree angle with respect to the top and bottom of the panel, or at another angle, as may be desired.

The bonding material used to connect the various components and elements of the house 10 may be any suitable bonding material such as epoxy, epoxy resin, glue, adhesive, adhering material or another bonding material (these terms may be used interchangeably and equivalently herein). In one embodiment, the bonding material is more flexible or bendable than the sandwich panels, and may, for example, be four or five times more flexible than the panels. The flexibility of the bonding material, therefore, reduces the likelihood than the joints of the monolithic structure will break or split, and also transmits loads from one panel to another, across the joint. The bonding material may include filling components, such as, fiberglass or a fiberglass and resin mixture, and may, for example, be microfiber and Aerosil® material.

The sandwich panels may be customized by cutting and removing a portion of the panel, e.g., portions 27 (FIG. 1), to form openings for windows or doors. The openings 27 may be cut to any desired size to accommodate the installation of any size window or door. It will be appreciated that the panel can be customized in any manner desired to meet the specifications of an architectural or design plan. The sandwich panels also may be cut in other designs to accommodate other roof, wall, etc. arrangements. It also will be appreciated that while the windows, door and roof are described as being cut from a solid sandwich panel, the openings may be molded or otherwise formed in the panel.

Although the invention has been shown and described with respect to a certain preferred embodiment or embodiments, it is obvious that equivalent alterations and modifications will occur to others skilled in the art upon the reading and understanding of this specification and the annexed drawings.

1. A structural component comprising:
a first sandwich panel bent to bound at least part of an area;
a number of generally planar sandwich panels arranged to form a stack of sandwich panels, the stack of sandwich panels at least partially in the area bounded by the first sandwich panel;
the first sandwich panel and the stack of sandwich panels being cooperative with one another to form a columnar structural component.

2. The structural component of claim 1, wherein the first sandwich panel includes a number of sets of recesses and the first sandwich panel is bent in the area of the sets of recesses.

3. The structural component of claim 2, wherein each of the number of sets of recesses includes at least one substantially continuous channel.

4. The structural component of claim 3, wherein the at least one substantially continuous channel has a triangular cross-section.

5. The structural component of claim 3, wherein the number of sets of recesses includes a first set of recesses and a second set of recesses and wherein the first sandwich panel has a first curved corner at the first set of recesses and a second curved corner at the second set of recesses.

6. The structural component of claim 1, wherein the first sandwich panel includes a first edge and a second edge and wherein the first edge is substantially coplanar with the second edge.

7. The structural component of claim 6, wherein the stack of sandwich panels includes an edge that is substantially coplanar with the first edge and the second edge of the first sandwich panel.

8. The structural component of claim 7, wherein the stack of sandwich panels is retained in the area bound by the first sandwich panel with a connecting member.

9. The structural component of claim 8, wherein the connecting member is a planar element that is connected to the first edge and the second edge of the of the first sandwich panel.

10. The column of claim 9, wherein the connecting member is at least one layer of laminate material.

11. The column of claim 1, wherein the stack of sandwich panels includes a number of stiffeners.

12. A method of forming a columnar structural component comprising:
bending a sandwich panel to at least partially bound an area;
arranging a number of generally planar sandwich panels in a stack; and
cooperatively engaging the stack of sandwich panels and the sandwich panel such that the stack of sandwich panels is at least partially in the area bounded by the sandwich panel.

13. The method of claim 12, further comprising forming a number of sets of recesses in the sandwich panel and bending the sandwich panel in the area of the sets of recesses.

14. The method of claim 13, wherein the forming includes forming a first set of recesses and a second set of recesses in the sandwich panel, and the bending includes bending the sandwich panel at the first set of recesses to form a first round corner and bending the sandwich panel at the second set of recesses to form a second round corner.

15. The method of claim 13, wherein the forming includes forming a number of recesses having a triangular cross-section.

16. The method of claim 12, wherein the bending further comprises bending the sandwich panel such that a first edge of the sandwich panel is generally coplanar with a second edge of the sandwich panel.

17. The method of claim 12, wherein the cooperatively engaging comprises inserting the stack of sandwich panels at least partially into the area bounded by the sandwich panel.

18. The method of claim 12, wherein the cooperatively engaging includes bending the sandwich panel at least partially around the stack of sandwich panels.

19. The method of claim 12, wherein the cooperatively engaging comprises inserting the stack of sandwich panels into the area bounded by the sandwich panel such that an edge of the stack of sandwich panels is coplanar with a first edge and a second edge of the sandwich panel.

20. (canceled)

21. A column comprising:
a first sandwich panel having a first edge and a second edge;
a number of generally planar sandwich panels arranged in a stack of sandwich panels, wherein the stack of sandwich panels is at least partially surrounded by the first sandwich panel; and
a connecting member connected to the first edge and the second edge of the first sandwich panel.

22-26. (canceled)
